(19) United States
(12) Patent Application Publication
(10) Pub. No.: US 2024/0380233 A1
(43) Pub. Date: Nov. 14, 2024

(54) BATTERY SYSTEM

(71) Applicant: TOYOTA JIDOSHA KABUSHIKI KAISHA, Toyota-shi (JP)

(72) Inventors: Hideki HAGIWARA, Nagoya-shi (JP); Hiroshi Nagase, Nagoya-shi (JP); Yasumasa Oguma, Nagoya-shi (JP); Jun Yoshida, Mishima-shi (JP); Tsubasa Migita, Osaka (JP); Yoshihiro Uchida, Nagakute-shi (JP)

(73) Assignee: TOYOTA JIDOSHA KABUSHIKI KAISHA, Toyota-shi (JP)

(21) Appl. No.: 18/418,475

(22) Filed: Jan. 22, 2024

(30) Foreign Application Priority Data
May 10, 2023 (JP) 2023-077956

(51) Int. Cl. H02J 7/00; H01M 10/46; H01M 10/48

(52) U.S. Cl. CPC H02J 7/007194; H01M 10/46; H01M 10/482; H01M 10/486; H02J 7/0013; H02J 7/0047; H02J 7/0063

(57) ABSTRACT

The ECU performs a step of determining whether charging/discharging control is being executed, a step of acquiring the temperature of the terminal portion when it is determined that charging/discharging control is being executed, and a step of determining the charging power limit value, a step of setting a discharge power limit value, and a step of performing charge/discharge control using the set charge power limit value and the set discharge power limit value.

### CROSS-REFERENCE TO RELATED APPLICATION

This application claims priority to Japanese Patent Application No. 2023-077956 filed on May 10, 2023, incorporated herein by reference in its entirety.

### BACKGROUND

### 1. Technical Field

The present disclosure relates to battery systems.

### 2. Description of Related Art

For example, all-solid-state batteries using a solid electrolyte are known as secondary batteries. For example, a laminate film having a heat-sealed seal portion is sometimes used as an exterior covering cells of all-solid-state batteries. For such cells covered by the laminate film, for example, Japanese Unexamined Patent Application Publication No. 2021-114373 (JP 2021-114373 A) discloses a technology in which the water permeability is calculated based on the temperature of the seal portion, and a control for cooling the seal portion is performed when the water permeability is equal to or higher than a threshold.

### SUMMARY

However, such a laminate film covering the cells is not only affected by entry of water, but may be affected by, for example, heat generated by the cells or heat received from adjacent cells. When the temperature of the terminals of the cells increases due to heat generation or heat reception, the durability as an exterior of the laminate film that is in close contact with the terminals may be affected.

The present disclosure was made to solve the above problem, and it is an object of the present disclosure to provide a battery system that reduces reduction in durability of an exterior for cells.

A battery system according to an aspect of the present disclosure includes: an all-solid-state battery; an acquisition device configured to acquire temperature information on a temperature of a terminal of a cell of the all-solid-state battery; and a control device configured to control transmission power that is transmitted between the all-solid-state battery and an electrical device. The control device is configured to set an upper limit value for a magnitude of the transmission power using the temperature information acquired by the acquisition device.

With this configuration, the upper limit value can be set according to the temperature of the terminal. For example, the upper limit value can be set to a lower value when the temperature of the terminal is high. An increase in Joule heat generation in the terminal can be reduced by setting the upper limit value to a low value. It is therefore possible to reduce an increase in temperature of the terminal and reduce the influence on the durability of the laminate film.

In one embodiment, the acquisition device may include a temperature sensor provided for the terminal and configured to detect the temperature of the terminal. The control device may be configured to set the upper limit value to a lower value when the temperature of the terminal detected by the temperature sensor is high than when the temperature of the terminal is low.

With this configuration, the upper limit value can be set to a low value when the temperature of the terminal is high. It is therefore possible to reduce an increase in Joule heat generation in the terminal. Accordingly, it is possible to reduce an increase in temperature of the terminal and reduce the influence on the durability of the laminate film.

In another embodiment, the all-solid-state battery may include a plurality of the cells. The acquisition device may include at least one of the following components: a thermistor provided for the terminal of at least one of the cells, a surface pressure sensor provided between the cells, a temperature sensor provided for each of the cells, and a detection device configured to detect resistance values of the cells. The control device may be configured to estimate the temperature of the terminal using the temperature information acquired by the acquisition device and to set the upper limit value to a lower value when the estimated temperature of the terminal is high than when the estimated temperature of the terminal is low.

With this configuration, the temperature of the terminal can be accurately estimated using the temperature information acquired by the thermistor, the surface pressure sensor, the temperature sensor, or the detection device configured to detect the resistance value.

In still another embodiment, the all-solid-state battery may further include a bus bar connecting the cells. The battery system may further include a current sensor configured to detect a current flowing through the bus bar. The control device may be configured to estimate the temperature of the terminal using a detection result from the current sensor in addition to the temperature information acquired by the acquisition device.

With this configuration, the temperature of the terminal of the cell can be accurately estimated using a current value detected by the current sensor in addition to the temperature information acquired by the acquisition device.

In yet another embodiment, an exterior material for the cell of the all-solid-state battery may be a laminate film.

With this configuration, influence on the durability of the laminate film can be reduced by reducing an increase in temperature of the terminal of the cell.

According to the present disclosure, it is possible to provide a battery system that reduces reduction in durability of an exterior for cells.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of the configuration of a vehicle equipped with a battery system according to the present embodiment;

FIG. 2 is a diagram showing an example of the configuration of a battery pack;

FIG. 3 is a flowchart showing an example of processing executed by the ECU;

FIG. 4 is a diagram showing an example of a map showing the relationship between temperature and limit value; and

FIG. 5 is a diagram for explaining an example of the configuration of a battery pack in a modified example.

### DETAILED DESCRIPTION OF EMBODIMENTS

Hereinafter, embodiments of the present disclosure will be described in detail with reference to the drawings. It should be noted that the same or corresponding parts in the drawings are designated by the same reference characters and repetitive description will be omitted.

In the following, a case where the battery system 90 according to the present embodiment is installed in a battery electric vehicle (hereinafter referred to as a vehicle) 1 will be described as an example.

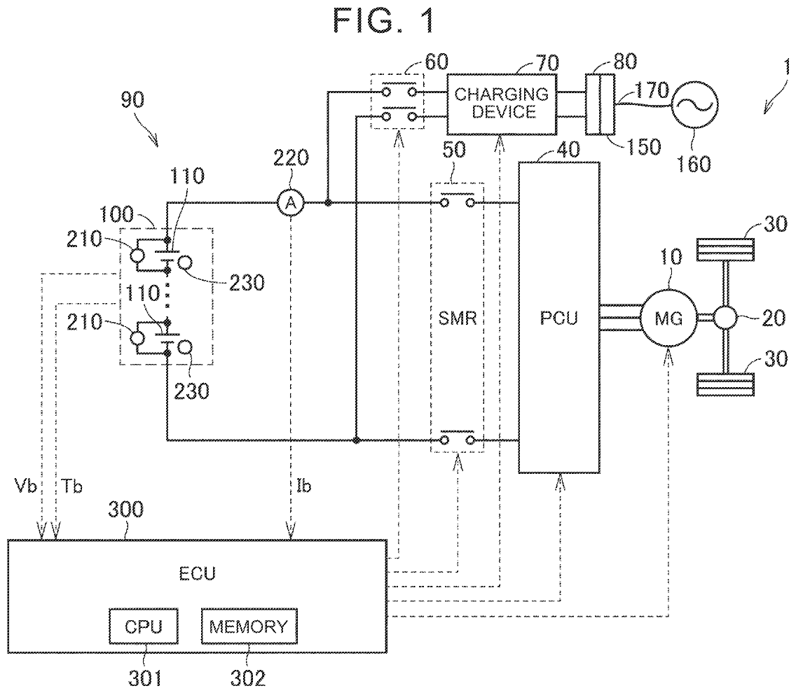

FIG. 1 is a diagram showing an example of the configuration of a vehicle 1 equipped with a battery system 90 according to the present embodiment. As shown in FIG. 1, the vehicle 1 includes a Motor Generator (MG) 10, a power transmission gear 20, drive wheels 30, a Power Control Unit (PCU) 40, a System Main Relay (SMR) 50, and a charging relay (hereinafter referred to as CHR) 60, a charging device 70, an inlet 80, a battery pack 100, and an Electronic Control Unit (ECU) 300. Battery system 90 in this embodiment includes PCU 40, charging device 70, battery pack 100, and ECU 300. Battery system 90 may further include SMR 50 and CHR 60.

The MG 10 is, for example, a three-phase AC rotating electrical machine, and has functions as an electric motor and a generator. The output torque of the MG 10 is transmitted to drive wheels 30 via a power transmission gear 20 that includes a reduction gear, a differential, and the like.

When braking the vehicle 1, the MG 10 is driven by the drive wheels 30, and the MG 10 operates as a generator. Thereby, the MG 10 also functions as a braking device that performs regenerative braking that converts the kinetic energy of the vehicle 1 into electric power. Regenerated power generated by regenerative braking force in MG 10 is stored in battery pack 100.

PCU 40 is a power conversion device that bidirectionally converts power between MG 10 and battery pack 100. PCU 40 includes, for example, an inverter and a converter that operate based on control signals from ECU 300.

The converter boosts the voltage supplied from the battery pack 100 and supplies it to the inverter when the battery pack 100 is discharged. The inverter converts the DC power supplied from the converter into AC power to drive the MG 10.

On the other hand, when charging the battery pack 100, the inverter converts the AC power generated by the MG 10 into DC power and supplies the DC power to the converter. The converter steps down the voltage supplied from the inverter to a voltage suitable for charging the battery pack 100 and supplies the voltage to the battery pack 100.

Furthermore, PCU 40 stops charging and discharging by stopping the operations of the inverter and converter based on the control signal from ECU 300. Note that the PCU 40 may have a configuration in which the converter is omitted.

SMR 50 is electrically connected to a power line connecting battery pack 100 and PCU 40. When SMR 50 is closed (that is, in a conductive state) in response to a control signal from ECU 300, power can be exchanged between battery pack 100 and PCU 40. On the other hand, when the SMR 50 is opened in response to a control signal from the ECU 300 (that is, in a cutoff state), the electrical connection between the battery pack 100 and the PCU 40 is cut off.

CHR 60 is electrically connected between battery pack 100 and charging device 70. When the CHR 60 is closed (that is, in a conductive state) in response to a control signal from the ECU 300, and a connector 150 of a system power supply 160, which is an external power supply, is attached to an inlet 80, which will be described later, The battery pack 100 is now ready to be charged using the charging device 70. On the other hand, when CHR 60 is opened in response to a control signal from ECU 300 (that is, in a cutoff state), the electrical connection between battery pack 100 and charging device 70 is cut off.

The inlet 80 is provided on the exterior of the vehicle 1 together with a cover (not shown) such as a lid. The inlet 80 has a shape to which a connector 150 (described later) can be mechanically connected. Contacts are built into both the inlet 80 and the connector 150, and when the connector 150 is attached to the inlet 80, the contacts come into contact with each other, and the inlet 80 and the connector 150 are electrically connected.

Connector 150 is connected to system power supply 160 via charging cable 170. Therefore, when connector 150 is connected to inlet 80 of vehicle 1, power from system power supply 160 can be supplied to vehicle 1 via charging cable 170, connector 150, and inlet 80.

Charging device 70 is electrically connected to battery pack 100 via CHR 60 and to inlet 80. Charging device 70 converts AC power supplied from system power supply 160 into DC power and outputs it to battery pack 100 in response to a control signal from ECU 300. For example, when connector 150 is attached to inlet 80, charging device 70 charges battery pack 100 using power supplied from system power supply 160. Hereinafter, charging using such a system power supply 160 may be referred to as “external charging”.

The battery pack 100 is a power storage device that stores power for driving the MG 10. The battery pack 100 is a rechargeable DC power source, and is configured by, for example, a plurality of cells 110 connected in series. The cell 110 is a secondary battery in which a solid electrolyte is used to transfer ions between a positive electrode and a negative electrode, and is an all-solid-state battery whose constituent members are all solid-state. As the material constituting the cell 110, any material known as a material constituting an all-solid-state battery may be used, and will be described later.

A voltage sensor 210, a current sensor 220, and a terminal temperature sensor 230 are connected to the ECU 300.

The voltage sensor 210 detects a voltage Vb between terminals of each of the plurality of cells 110. The current sensor 220 detects a current Ib input to and output from the battery pack 100. The terminal temperature sensor 230 is provided at a positive terminal or a negative terminal of a plurality of cells 110, and detects the temperature Tb of the provided terminal (hereinafter referred to as terminal temperature). Each sensor outputs its detection result to ECU 300.

ECU 300 includes a Central Processing Unit (CPU) 301 and memory (Read Only Memory (ROM) and Random Access Memory (RAM)) 302. ECU 300 controls each device (for example, PCU 40 or charging device 70) so that vehicle 1 is in a desired state based on signals received from each sensor and information such as maps and programs stored in memory 302.

The amount of power stored in the battery pack 100 is generally managed by SOC, which indicates the ratio of the current amount of stored power to the full charge capacity as a percentage. ECU 300 has a function of sequentially calculating the SOC of battery pack 100 based on the values detected by voltage sensor 210, current sensor 220, and terminal temperature sensor 230. As a method for calculating the SOC, various known methods can be employed, such as a method based on current value integration (coulomb counting) or a method based on estimation of open circuit voltage (OCV).

While the vehicle 1 is driving, the battery pack 100 is charged or discharged by regenerated power or discharged power by the MG 10. The ECU 300 controls the output of the MG 10 so that power for generating the vehicle driving force (required driving force set according to the accelerator operation amount) or braking force (required deceleration force set according to the amount of brake pedal depression and vehicle speed) requested by the driver is output from the MG 10.

On the other hand, when the vehicle 1 is in a stopped state and the connector 150 is connected to the inlet 80, the ECU 300 turns on the CHR 60 and operates the charging device 70 so as to charge the battery pack 100 using the power from the system power supply 160.

For example, the ECU 300 continues charging until the SOC of the battery pack 100 reaches a preset upper limit (or is set according to the state of deterioration of the battery pack 100), and ends the charging when the SOC of the battery pack 100 reaches the upper limit.

For example, the ECU 300 sets a charging power limit value (hereinafter referred to as Win) when charging the battery pack 100 according to the temperature of the battery pack 100, etc., and controls the PCU 40 and the charging device 70 such that the battery pack 100 is not charged with charging power exceeding the limit value Win. Furthermore, the ECU 300 sets a discharge power limit value (hereinafter referred to as Wout) when discharging the battery pack 100 depending on the temperature of the battery pack 100, etc., and prevents the discharge power exceeding the limit value Wout from occurring. The PCU 40 is controlled so as not to be discharged.

The battery pack 100 mounted on the vehicle 1 having the above configuration includes a plurality of cells 110. The plurality of cells 110 are configured to be covered with a laminate or the like as an exterior, for example.

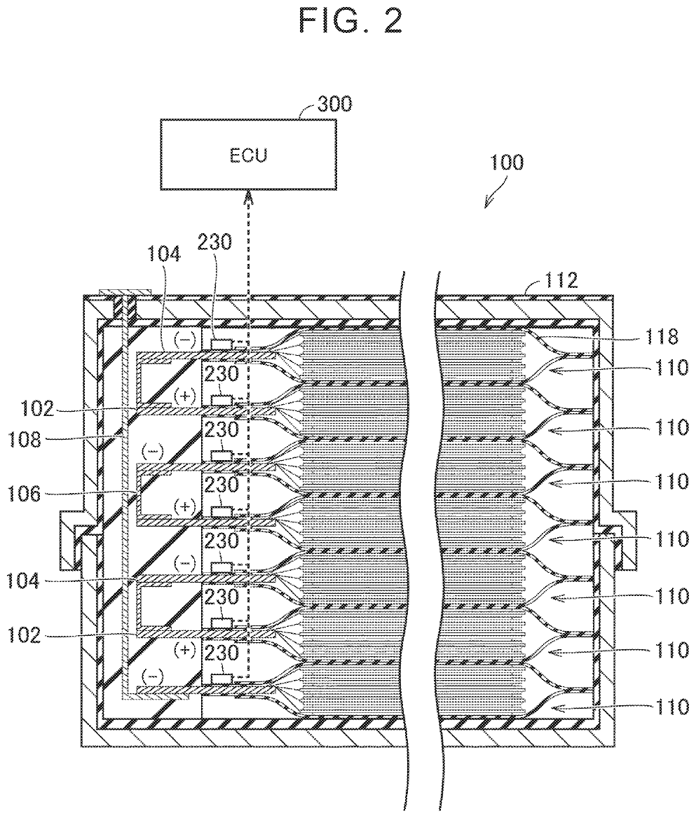

FIG. 2 is a diagram showing an example of the configuration of the battery pack 100. As shown in FIG. 2, the battery pack 100 includes: a plurality of cells 110 including a positive electrode terminal 102, a negative electrode terminal 104, and a laminate film 118 serving as an exterior; a positive electrode terminal 102 of one of the cells 110; a plurality of bus bars 106 that connect the cell to the negative electrode terminal 104 of the cell 110 adjacent to the cell; a battery case 112 housing a stack formed by stacking a predetermined number of cells (seven in FIG. 2); and a bus bar 108 has one end connected to the negative electrode terminal 104 serving as the terminal end.

Each of the plurality of cells 110 includes an electrode body including a positive electrode current collector layer, a positive electrode active material layer, a solid electrolyte layer, a negative electrode active material layer, and a negative electrode current collector layer.

The solid electrolyte material contained in the solid electrolyte layer is not particularly limited as long as it can be used as a solid electrolyte for an all-solid-state battery. The solid electrolyte material may be, for example, a sulfide-based amorphous solid electrolyte or an oxide-based amorphous solid electrolyte.

The active material contained in the positive electrode layer and the negative electrode layer is not particularly limited as long as it can be used as an electrode active material of an all-solid-state battery. Examples of active materials may include nickel cobalt lithium manganate (NCM), nickel cobalt aluminum lithium (NCA), lithium cobalt oxide (LCO), (lithium titanate) LTO, and lithium manganate (LMO).

The positive electrode layer and the negative electrode layer may contain conductive support particles. As the conductive aid particles, for example, graphite, carbon black, etc. can be used.

The material for the positive electrode current collector and the negative electrode current collector is not particularly limited as long as it has conductivity and functions as a positive electrode current collector and a negative electrode current collector, for example, Steel. Examples include Use Stainless (SUS), aluminum, copper, nickel, iron, titanium, and carbon. Further, the shapes of the positive electrode current collector and the negative electrode current collector include, for example, a foil shape, a plate shape, a mesh shape, and the like. A positive electrode terminal is connected to the positive electrode current collector. A negative electrode terminal is connected to the negative electrode current collector.

The electrode body includes a first element in which a positive electrode current collector layer, a positive electrode active material layer, a solid electrolyte layer, a negative electrode active material layer, and a negative electrode current collector layer are laminated in this order, and a negative electrode current collector. The device includes a second element that shares a layer and is laminated in the reverse order, and is constituted by a plurality of first elements and second elements that are alternately laminated. Each of the negative electrode current collector layers of the plurality of elements is connected to the negative electrode terminal 104 of the cell 110, and each of the positive electrode current collector layer of the plurality of elements is connected to the positive electrode terminal 102 of the cell 110. The positive electrode terminal 102 and negative electrode terminal 104 of the cell 110 are arranged in the direction from the back to the front of the paper in FIG. 2. Cells 110 and adjacent cells 110 are stacked such that their positive electrode terminals 102 and negative electrode terminals 104 are in a positional relationship facing each other. FIG. 2 shows a cross section including either the positive electrode terminal 102 or the negative electrode terminal 104 of the plurality of cells 110.

As shown in FIG. 2, each electrode body of the plurality of cells 110 is covered with a laminate film 118 as an exterior. The laminate film 118 prevents dust and water from entering the inside by being in close contact with the terminal portions (positive electrode terminal 102 and negative electrode terminal 104) of the electrode body.

In the battery pack 100 having the above configuration, the laminate film 118 that covers the electrode bodies of the plurality of cells 110 as described above may be affected by heat received from other adjacent cells 110 via the bus bar 106. That is, when the temperature of the terminal of the cell 110 increases via the bus bar 106, there is a possibility that the durability of the laminate film 118 that is in close contact with the terminal portion may be affected.

Therefore, in the present embodiment, ECU 300 uses temperature information on the temperature of the terminal portions of a plurality of cells 110, which are all-solid-state batteries, to set the upper limit value for the magnitude of transmission power that is transmitted between the battery pack 100 and the electrical equipment (for example, PCU 40 or charging device 70).

In this way, the upper limit value can be set in accordance with the temperature of the terminal portion, such as setting the upper limit value low when the terminal portion of any one of the cells 110 among the plurality of cells 110 is high. It is possible to suppress the temperature of the terminal portion from affecting the durability of the laminate film 118 serving as the exterior.

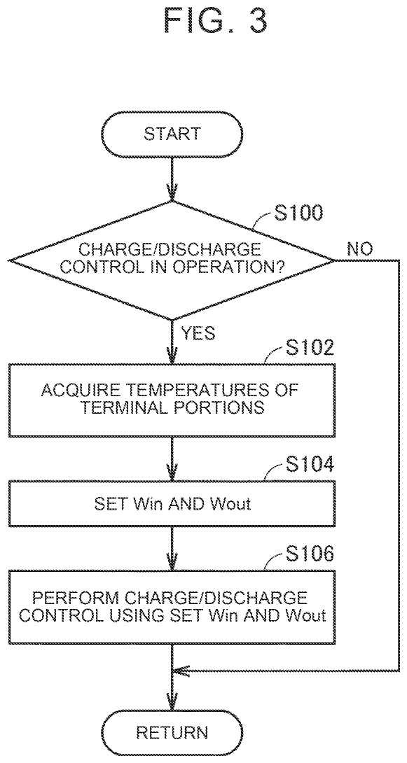

An example of processing executed by ECU 300 will be described below with reference to FIG. 3. FIG. 3 is a flowchart illustrating an example of processing executed by ECU 300. A series of processes shown in this flowchart are repeatedly executed by the ECU 300 at predetermined intervals while the vehicle 1 is driving or being charged using an external power source.

At step (hereinafter referred to as S) 100, ECU 300 determines whether charge/discharge control is being executed. ECU 300 determines that charging and discharging control is being executed when either charging control or discharging control is being executed for battery pack 100. For example, ECU 300 may determine that either charging control or discharging control is being performed when the magnitude of the current detected by current sensor 220 is equal to or greater than a predetermined value. Alternatively, the ECU 300 outputs a control signal to the PCU 40 to perform either charging control or discharging control, and then outputs a control signal to stop the control. If not, it may be determined that either charging control or discharging control is being performed. Alternatively, if the ECU 300 is turned on when either charging control or discharging control is executed, and turned off when the control is stopped, the flag is turned on. It may be determined that either charging control or discharging control is being executed. If it is determined that charge/discharge control is being executed (YES in S100), the process moves to S102.

In S102, ECU 300 uses terminal temperature sensor 230 to obtain the temperature of the terminal portion of each of the plurality of cells 110.

In S104, ECU 300 sets a charging power limit value Win and a discharging power limit value Wout.

Specifically, the ECU 300 specifies, for example, the maximum temperature (hereinafter referred to as maximum temperature) among the temperatures of the terminal portions of each of the plurality of cells 110, and determines the temperature corresponding to the specified maximum temperature. A charging power limit value Win and a discharging power limit value Wout are set. Note that the ECU 300 may set the limit values Win and Wout using an average value of the temperatures of the terminal portions of each of the plurality of cells instead of the maximum temperature.

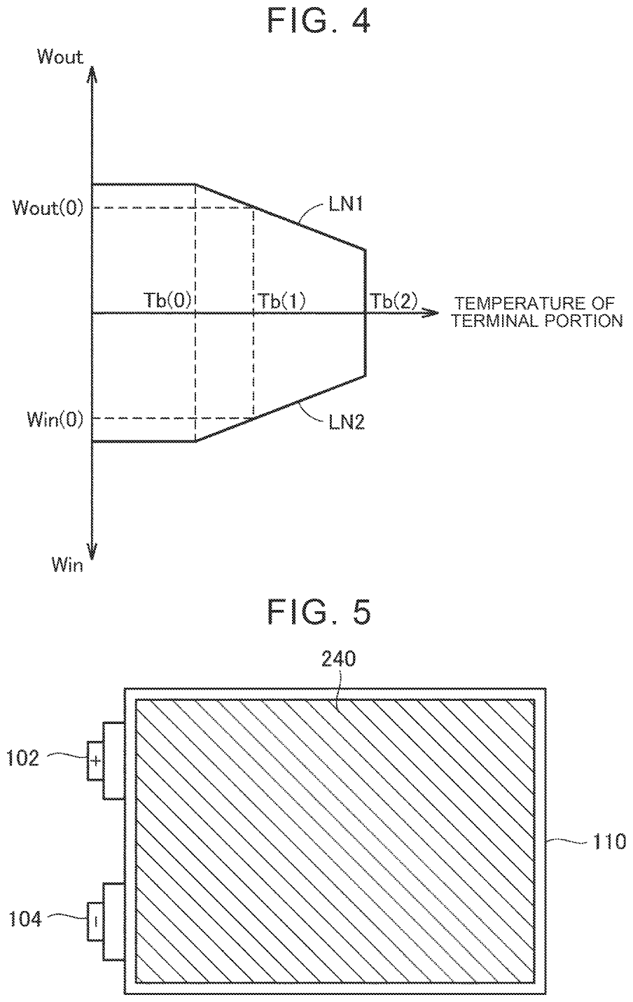

ECU 300 sets the charging power limit value Win and the discharging power limit value Wout from the maximum temperature specified using, for example, a map showing the relationship between temperature and limit value. FIG. 4 is a diagram showing an example of a map showing the relationship between temperature and limit value. The horizontal axis in FIG. 4 indicates the temperature of the terminal portion. The vertical axis in FIG. 4 indicates a charging power limit value Win (negative direction) and a discharging power limit value Wout (positive direction). LN1 in FIG. 4 indicates a change in the discharge power limit value Wout with respect to a temperature change in the terminal portion. LN2 in FIG. 4 indicates a change in the limit value Win of charging power with respect to a change in temperature of the terminal portion.

As shown in LN1 in FIG. 4, the relationship between the temperature of the terminal portion and the limit value Wout of the discharge power is such that the limit value Wout of the discharge power is set to a predetermined value Wout(1) until the temperature of the terminal portion reaches a predetermined first temperature Tb(0). The relationship between the temperature of the terminal portion and the limit value Wout of the discharge power is such that when the temperature of the terminal portion becomes equal to or higher than the first temperature Tb(0), the limit value Wout is set so that the magnitude of the limit value Wout decreases as the temperature of the terminal portion increases. That is, when the temperature of the terminal portion is high, the discharge power limit value Wout is set so that the magnitude is smaller than when the temperature is low.

The first temperature Tb(0) is adapted, for example, by experiment. Furthermore, the relationship between the temperature of the terminal portion and the limit value Wout of the discharge power is such that when the temperature of the terminal portion is equal to or higher than a predetermined second temperature Tb(1), the limit value Wout of the discharge power is set to zero.

Further, as shown in LN2 in FIG. 4, the relationship between the temperature of the terminal portion and the limit value Win of charging power is that until the temperature of the terminal portion reaches the first temperature Tb(0), the limit value Win of charging power is set to a predetermined value Win(1). The relationship between the temperature of the terminal portion and the charging power limit value Win is such that when the temperature of the terminal portion becomes equal to or higher than the first temperature Tb(0), charging becomes smaller as the temperature of the terminal portion becomes higher. The relationship is such that a power limit value Win is set. That is, when the temperature of the terminal portion is high, the charging power limit value Win is set so that the magnitude is smaller than when the temperature is low. Furthermore, the relationship between the temperature of the terminal portion and the limit value Win of charging power is such that when the temperature of the terminal portion becomes equal to or higher than the second temperature Tb(1), the limit value Win of charging power is set to zero. Note that the relationship between the temperature of the terminal portion and the limit value shown in LN1 and LN2 in FIG. 4 is an example, and is not particularly limited to the relationship shown in FIG. 4.

Therefore, for example, when it is specified that the maximum temperature in the plurality of cells 110 is Tb(1), the ECU 300 sets Wout(0) as the discharge power limit value Wout, and also sets the charge power limit to Wout(0). Win(0) is set as the value Win. The process then moves to S106.

In S106, ECU 300 executes charging/discharging control using the set charge power limit value Win and the set discharge power limit value Wout.

For example, while charging the battery pack 100, the ECU 300 controls the current supplied to the battery pack 100 so that the amount of charging power does not exceed the limit value Win. For example, when charging the battery pack 100 using an external power source, the ECU 300 uses the charging device 70 to perform the above-described current control. Furthermore, for example, when charging the battery pack 100 during operation, the ECU 300 uses the PCU 40 to execute the above-described current control.

On the other hand, while the battery pack 100 is discharging, the ECU 300 controls the current supplied from the battery pack so that the discharge power does not exceed the limit value Wout. For example, when discharging the battery pack 100 during operation, the ECU 300 uses the PCU 40 to execute the above-described current control.

An example of the operation of the battery system 90 based on the above structure and flowchart will be described.

For example, assume that the battery pack 100 is being charged using an external power source. When charge/discharge control is being executed (YES in S100), the terminal temperature of each of the plurality of cells 110 is obtained by acquiring the detection result of the terminal temperature sensor 230 provided in each of the plurality of cells 110 (S102).

The maximum temperature among the acquired terminal temperatures is specified, and the charging power limit value Win and the discharging power limit value Wout are set from the relationship among the specified maximum temperature, the temperature of the terminal portion, and the limit value shown in FIG. 4 (S104). Then, charging and discharging control is executed using the set charging power limit value Win and the set discharge power limit value Wout (S106). Therefore, while charging the battery pack 100, the current supplied to the battery pack 100 is controlled using the charging device 70 so that the amount of charging power does not exceed the set charging power limit value Win. As a result, heat generation in each of the plurality of cells 110 is suppressed.

As described above, according to the battery system 90 according to the present embodiment, the upper limit values (limit values Win and Wout) are set in accordance with the temperature of the terminal portion, such as setting the upper limit value low when the temperature of the terminal portion is high. Thus, it is possible to suppress the temperature of the terminal portion from affecting the laminate film 118. Therefore, it is possible to provide a battery system that suppresses deterioration of the durability of the cell exterior.

Furthermore, since each limit value is set so that the magnitude of the limit value decreases as the temperature of the terminal portion detected by the terminal temperature sensor 230 increases. It is therefore possible to reduce the influence of the temperature of the terminal on the laminate film 118.

Modifications will be described below.

In the embodiment described above, the charging power limit value Win and the discharging power limit value Wout are determined using the temperature of the terminal portion acquired by the terminal temperature sensor 230 provided at either the positive terminal or the negative terminal of the cell 110. Although the description has been made assuming that the temperature is set, the present disclosure is not particularly limited to obtaining the temperature of the terminal portion using the terminal temperature sensor 230.

For example, the maximum temperature among the temperatures of each of the plurality of cells 110 may be obtained using the detection result of the resistance value of a thermistor provided at the terminal portion of at least one of the plurality of cells 110. The thermistors may be provided, for example, at a plurality of locations where the temperature is higher than others among the plurality of cells 110 that constitute the battery pack 100.

Alternatively, for example, the maximum temperature among the temperatures of each of the plurality of cells 110 may be obtained using the detection result of a temperature sensor provided at a location other than the terminal portion of the plurality of cells 110.

Alternatively, for example, the maximum temperature of the temperatures of each of the plurality of cells 110 may be obtained using the detection result of a surface pressure sensor provided between at least any two of the plurality of cells 110. FIG. 5 is a diagram for explaining an example of the configuration of a battery pack 100 in a modified example. As shown in FIG. 5, a surface pressure sensor 240 is provided so as to cover the entire surface in the stacking direction between each of the plurality of cells 110. Surface pressure sensor 240 includes a plurality of surface pressure measurement points, detects the pressure acting at the measurement points, and transmits information indicating the detected pressure and information indicating the position of the measurement points to ECU 300. The ECU 300 may estimate the amount of expansion of the plurality of cells 110 using the received pressure, estimate the temperature of the terminal portion from the estimated amount of expansion, and obtain the maximum temperature of the temperatures of each of the plurality of cells 110.

Alternatively, the ECU 300 may detect the resistance value (internal resistance) of each of the plurality of cells 110. ECU 300 may detect the resistance value of each of the plurality of cells 110, for example, by detecting the voltage and current applied to each of the plurality of cells 110. ECU 300 may estimate the temperature of each of the plurality of cells 110 using the detected resistance value, and obtain the maximum temperature of each of the plurality of cells 110 using the estimated temperature.

By using temperature information regarding the temperature of the terminal portion as described above, the temperature of the terminal portion of the cell 110 can be estimated with high accuracy.

Furthermore, in addition to the temperature information obtained using the above-mentioned thermistor, surface pressure sensor, temperature sensor, or detection device that detects resistance value, the current value that flows through the bus bar 106 connecting each of the plurality of cells 110 is detected. The temperature of the terminal portion may be estimated using the current sensor 220.

For example, the ECU 300 may correct the temperature of the terminal portion of each cell obtained using the temperature information using the current value shown in the detection result of the current sensor 220. ECU 300 may correct, for example, such that the higher the current value of current sensor 220, the higher the temperature of the terminal portion. The heat generated at the terminal portions (Joule heat) also contributes to the current flowing in the bus bar. Therefore, by estimating the temperature of the terminals using the current value in addition to temperature information as described above, the temperature of the terminal portions can be accurately estimated.

All or some of the above-mentioned modified examples may be combined for implementation.

It should be considered that the embodiments disclosed above are for illustrative purposes only and are not limitative of the disclosure in any aspect. The scope of the disclosure is represented by the appended claims, not by the above description, and includes all modifications within the meanings and scope equivalent to the claims.

What is claimed is:

1. A battery system, comprising:
an all-solid-state battery;
an acquisition device configured to acquire temperature information on a temperature of a terminal of a cell of the all-solid-state battery; and
a control device configured to control transmission power that is transmitted between the all-solid-state battery and an electrical device, wherein the control device is configured to set an upper limit value for a magnitude of the transmission power using the temperature information acquired by the acquisition device.

2. The battery system according to claim 1,
wherein the acquisition device includes a temperature sensor provided for the terminal and configured to detect the temperature of the terminal, and
wherein the control device is configured to set the upper limit value to a lower value when the temperature of the terminal detected by the temperature sensor is high than when the temperature of the terminal is low.

3. The battery system according to claim 1,
wherein the all-solid-state battery includes a plurality of the cells,
wherein the acquisition device includes at least one of the following components: a thermistor provided for the terminal of at least one of the cells, a surface pressure sensor provided between the cells, a temperature sensor provided for each of the cells, and a detection device configured to detect resistance values of the cells, and
wherein the control device is configured to estimate the temperature of the terminal using the temperature information acquired by the acquisition device and to set the upper limit value to a lower value when the estimated temperature of the terminal is high than when the estimated temperature of the terminal is low.

4. The battery system according to claim 3,
wherein the all-solid-state battery further includes a bus bar connecting the cells, the battery system further comprising a current sensor configured to detect a current flowing through the bus bar, and
wherein the control device is configured to estimate the temperature of the terminal using a detection result from the current sensor in addition to the temperature information acquired by the acquisition device.

5. The battery system according to claim 1, wherein an exterior material for the cell of the all-solid-state battery is a laminate film.
